(19) United States
(12) Patent Application Publication
(10) Pub. No.: US 2018/0131585 A1
(43) Pub. Date: May 10, 2018

(54) Cloud Visualization and Management Platform

(71) Applicant: 2nd Watch, Inc., Liberty Lake, WA (US)

(72) Inventors: Kris Bliesner, Liberty Lake, WA (US); James Scott Connell, Spokane, WA (US); Jason Carver, Spokane Valley, WA (US)

(73) Assignee: 2nd Watch, Inc.

(21) Appl. No.: 15/345,874

(22) Filed: Nov. 8, 2016

(51) Int. Cl. H04L 12/26; H04L 12/24; H04L 29/08

(52) U.S. Cl. CPC H04L 43/045; H04L 67/10; H04L 67/36; H04L 41/22

(57) ABSTRACT

Techniques for providing visualizations of changes in characteristics of a cloud-based network of resources over a period of time are described herein. The techniques may include obtaining data from a cloud-service provider representing changes in the characteristics of cloud-based resources for the period of time. Thereafter, a cloud management platform may transform the data by employing algorithms of an intermediate model to create a description of a visualization of the changes in the characteristics of the cloud-based network of resources. In some instances, the intermediate model may use one or more parameters included in a request from a client device to create the description of the visualization. The intermediate model may be used to provide the description of the visualization of the changes in the characteristics of the cloud-based network of resources over the period of time to be presented on a display of the client device.

### BACKGROUND

A growing number of businesses and individuals are subscribing to services offered by providers of cloud-based resources (i.e., Infrastructure-as-a-Service (IaaS), Platform-as-a-Service (PaaS), etc.) for their computing resource needs. Rather than individual subscribers having to invest upfront costs for the hardware and network infrastructure required for their computing needs, these cloud service providers offer Internet accessible computing resources, often contained in large, geographically disparate datacenters, which are provisioned according to each subscriber's needs for a fee.

Although the deployment and management of the equipment and hardware that provide the resources in the public cloud is often very static, the consumption of the resources provided by the equipment and hardware is highly elastic. Due to this elasticity, it is often difficult or impossible for consumers and providers to ascertain what cloud-based resources are available at any given time, what trends in consumption have looked like over time, and what caused changes in the consumption of these cloud-based resources. Analyzing extensive event logs of data that represent changes in the cloud-based resources is impractical for many consumers, and does not provide a depiction of how an entire network of resources behave over time.

### SUMMARY

This disclosure describes techniques directed to, in part, utilizing a cloud visualization and management platform to visualize the provisioning and consumption of cloud-based resources. In some implementations, the cloud visualization and management platform may comprise a server-side cloud management platform, which may include one or more server-side computing devices and/or entities. cloud management platform may monitor changes in characteristics of a cloud-based network of resources over time, or receive and/or store data which represents changes in characteristics of the cloud-based network of resources over time.

In some examples, the cloud management platform may receive a request from a client-side computing device to provide a representation of the changes in the characteristics of the cloud-based network of resources for a particular period of time. The cloud management platform may obtain data which represents the changes in the characteristics of the cloud-based network of resources from a database that corresponds to the particular period of time. Using this data, one or more components of the cloud management platform may be configured to apply algorithms or rules of an intermediate model to create the representation of the changes in the characteristics of the cloud-based network of resources for the particular period of time. In some instances, the intermediate model, may generate a description of a diagram that, when presented on a display of the client-side computing device, may cause a visual representation of the changes in the cloud-based network of resource to be illustrated on the display of the client-side computing device for the particular period of time.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a block depicting an example environment for providing a visualization of changes in characteristics of a cloud-based network of resources.

FIG. 2 illustrates example components of the example environment of FIG. 1 for obtaining data representative of changes in characteristics of a cloud-based network of resources, generating description using an intermediate model representing a visualization of the changes, and using the description to present the visualization of the changes.

FIG. 3 illustrates an example user interface usable for presenting a visualization of changes in characteristics of changes in characteristics of a cloud-based network of resources.

FIG. 4 illustrates example user interfaces usable for presenting visualizations of changes in several different characteristics of a cloud-based network of resources.

FIG. 5 illustrates an example process to receive a request to provide a representation of changes in characteristics of a cloud-based network of resources, and generating a representation of the changes in the characteristics of the cloud-based network.

FIG. 6 illustrates an example process to obtain a description representing changes in characteristics of a network of resources for a period of time, and presenting the description of the changes generated by the intermediate model.

FIG. 7 illustrates an example process to present a diagram representing characteristics of a cloud-based network of resources in a graphical user interface, and cause the diagram to be visually altered based on changes in the characteristics of the cloud-based network of resources.

### DETAILED DESCRIPTION

This disclosure describes techniques directed to, in part, utilizing a cloud visualization and management platform to provide a visualization of changes in characteristics of a cloud-based network of resources over time.

As noted above, many cloud-service providers provide network-based platforms (e.g., AMAZON WEB SERVICES®, MICROSOFT AZURE®, etc.) of Internet-accessible computing resources to customers which may be provisioned for each customer's needs. In this way, customers or subscribers of the network-based platforms may pay based on the amount of resources required for their computing needs. Such resources may include, but are not limited to, computing or processing power (e.g., virtual servers, auto scaling, load balancing, etc.), data storage and delivery (e.g., object storage, file system storage, block storage, etc.), database management (e.g., relational databases, database migration, caching, etc.), networking (e.g., virtual private cloud, direct connections, domain name system, etc.), or any other type of cloud-based resource, commodity, or service.

In some examples, the cloud-service providers may provide customers or other users with access to data representative of changes in consumption and characteristics of their provisioned cloud-based computing resources. For example, the cloud-service providers may provide access to one or more databases, subscription to one or more web-based application program interfaces (APIs), or other means to obtain data representative of their consumption and characteristics of their provisioned cloud resources. However, the data provided by these cloud-service providers may be provided in a form, such as an event log or listing, which is unintuitive, difficult to analyze, and difficult to visualize for a customer. Additionally, the data provided may simply be snapshots at a particular point in time of their private cloud network, which may not be helpful to a customer without any context of how their private cloud-based network behaves at other points in time.

Techniques describes herein include the utilization of a cloud management platform which obtains data provided by the cloud-service providers and transforms the data representative of the private cloud into a visualization which represents changes in the cloud-based network of resources for a period of time. In some examples, the cloud management platform obtains data which may be one or more snapshots representing the cloud-based network of resources at particular points in time, and additionally may be change notifications for the cloud-based network of resources subsequent to the point in time of the snapshot. The cloud management platform may include one or more components configured to apply one or more rules or algorithms of an intermediate model to convert the data into a description that, when presented on a display, visually represents the changes in the characteristics of the cloud-based network of resources. For example, the one or more components of the cloud management platform may continuously or periodically obtain the data representative of the cloud-based network of resources. Using this data, the one or more components may utilize the intermediate model to generate or otherwise maintain a description which represents changes in characteristics of the cloud-based network of resources.

To generate or maintain the description, the one or more components of the cloud-based network of resources may apply one or more algorithms or rules of the intermediate model to the input data obtained from the cloud-service providers. The input data, which may be resource characteristics of the cloud-based network of resources, may include a set of criteria defining what specific characteristics to use for generating the visual description of the changes. For example, the set of criteria may comprise a time or date range for which a representation of the cloud-based network is requested, security information, network information, intrinsic resource attributes (e.g., size, type, class, tag, etc.), cost range, service level, etc. The one or more components may apply the algorithms of the intermediate model using the input data and the set of criteria to determine how to appropriately output or generate a visual representation or description of the changes in the characteristics of the cloud-based network of resources. For instance, the one or more components may determine relationships between various resources, such as security relationships between resources, cost relationships between resources, communication connection relationships between resources, provisioning relationships between resources, or any other types of virtual or physical relationships between resources.

In some examples, the one or more components may then apply filters to narrow the set of resources based on the set of criteria, and determine the most appropriate visual representation to represent the data visually. As an example, a security topology may be depicted more appropriately as a graph, whereas a cost topology may be more appropriately depicted as a histogram. Upon determining the appropriate visual representation, the one or more components may utilize the intermediate model to generate the description in a particular format to be presented on a display.

In various examples, the cloud management platform may receive a request from a client or consumer device for the visualization of the changes in the cloud-based network of resources. In such examples, the request may include parameters, such as the one or more of the criteria of the set of criteria as well as the particular format in which the visualization is to be presented. Responsive to receiving the request, the one or more components of the cloud management platform may utilize the intermediate model to generate the appropriate description based on the parameters of the request. Upon generating the description, the cloud management platform may provide the description to the client device that requested the description.

In other examples, the cloud management platform may maintain one or more intermediate models representing the changes in the characteristics of the cloud-based network of resources in real-time or near-real-time. In this way, the cloud management platform may not need to generate a description responsive to a request, but could instead simply provide an already existing, up-to-date description using the intermediate models.

As discussed above, the intermediate model may generate a description that, when presented on a display, provides a visualization of changes in characteristics of the cloud-based network of resources. As one example, the description may represent changes in consumption of processing power provided to a particular customer in their personal cloud-based network of resources. However, rather than simply observing how processing load increases or decreases for a particular resource, such as a virtual machine or a group of virtual machines, the description may present a visualization of all of the changes in the resources contained in the cloud-based network of resources. For instance, the description of the visualization may illustrate how the load-balancing rules are being applied to their particular network of resources by visually depicting how various resources may increase their processing load, while other resources decrease their processing load.

The techniques described herein affect computer operations and data in various ways. For example, as noted above the cloud management platform may include one or more components which apply various algorithms or sets of rules to input data. In various instances, this input data may simply comprise event logs, or lines of text. By applying the various rules and algorithms, the one or more components of the cloud management platform may employ one or more processors to transform the data into a different and more useful format, such as an Extensible Markup Language (XML). Rather than having to parse through lines of text, the data is transformed into a format that presents a visualization of the data. Moreover, in various examples the specific algorithms do not merely convert text to XML, but may instead use a unique set of criteria, parameters, and rules specific to converting data related cloud-based resource usage and changes. For instance, the algorithms may comprise rules to convert the data based on criteria such as a time or date range for which a representation of the cloud-based network is requested, security information, network information, intrinsic resource attributes (e.g., size, type, class, tag, etc.), cost range, service level, etc.

Although the cloud-service provider(s) and cloud management platform may be described as different entities throughout this disclosure, it is contemplated that the cloud-service provider(s) and cloud management platform may comprise a single entity, a single computing device, a plurality of entities, or a plurality of computing devices configured to perform the operations described herein.

This brief introduction is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Example Environments

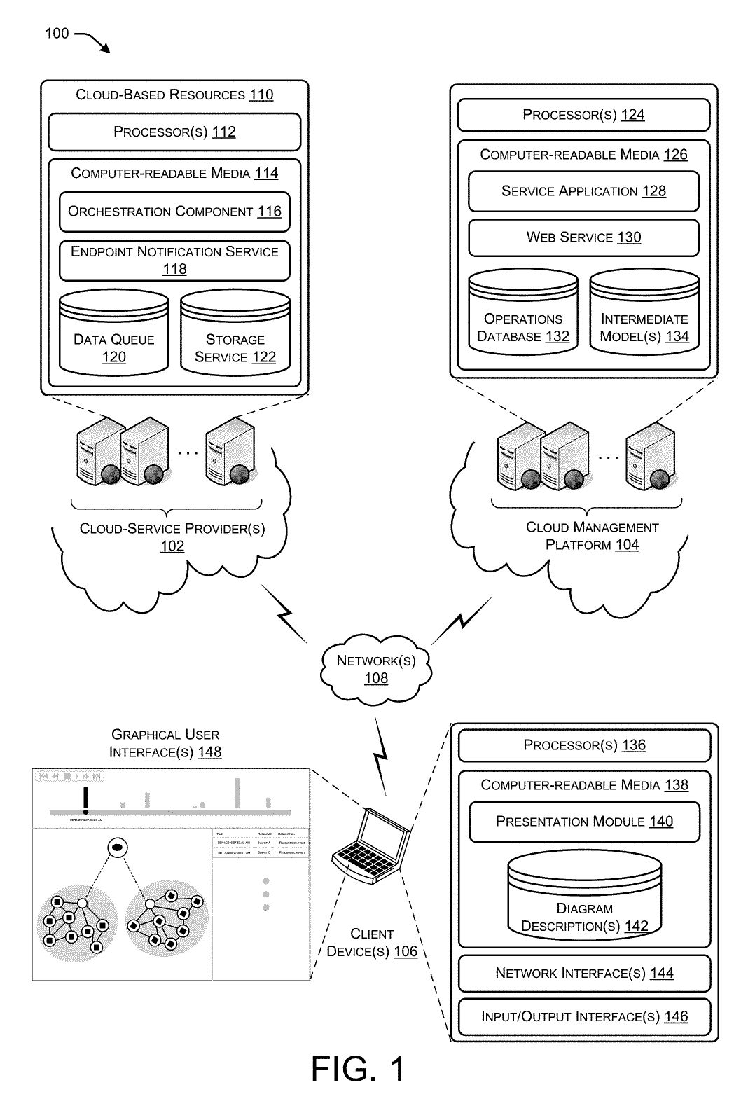

FIG. 1 illustrates an example environment 100 for providing a visualization of changes in characteristics of a cloud-based network of resources. The environment 100 may include one or more cloud-service providers 102, a cloud management platform 104, and one or more client devices 106 that can communicate with each other via one or more networks 108.

As noted above, cloud service provider(s) 102 may comprise any type of entity which provide various cloud-based and cloud-accessible computing resources. In various examples, cloud service provider(s) 102 may be any of, or any combination of, an entity, server(s), platform, console, computer, etc. which provides these cloud-based computing resources. Cloud service provider(s) 102 may include one or more cloud-based resources 110. As noted above, the cloud-based resources 110 of the cloud-service provider(s) 102 may comprise any type of network-based resource or instance, including but not limited to computing or processing power, data storage and delivery, database management, and networking. Cloud-based resources 110 may be partitioned into virtual and/or physical partitions which correspond to individual customer's computing needs. For example, a customer may have an account with the cloud-service provider(s) 102 where the subscriber pays for an allocation of the cloud-based resources 110, such as a private cloud network, to provide for their computing needs.

Cloud-based resources 110 may include one or more processors 112, and computer-readable media 114 storing various components. For instance, the computer-readable media 114 may include an orchestration component 116, an endpoint notification service 118, a data queue 120, and a storage service 122.

In various examples, the orchestration component 116 may comprise computer-readable instructions that, when executed by the processor(s) 112, perform operations for providing data to the customers regarding the private cloud network. In some examples, the orchestration component 116 may monitor the cloud-based resources 110 for customers and provide snapshots of the cloud-based resources 110 at particular points in time. The snapshots may comprise representations of the consumption and usage of the cloud-based resources 110 for particular customers at static points in time. The orchestration component 116 may create or otherwise obtain these snapshots and store them in a data store, such as storage service 122. In some examples, the orchestration component 116 may further be configured to periodically, or continuously, provide change notifications to the endpoint notification service 118. More specifically, the orchestration component 116 may monitor changes in the cloud-based resources 110 and provide change notifications, such as textual event logs or other data representations, of the changes in the cloud-based resources 110 to the endpoint notification service 118.

The endpoint notification service 118 may comprise computer-readable instructions that, when executed by the processor(s) 112, perform operations for receiving the change notifications from the orchestration component 116 of the cloud-service provider(s) 102. In various examples, the endpoint notification service 118 may be subscribed to by a queue, such as data queue 120, which stores the change notifications representing changes in the cloud-based resources 110.

In various examples, the cloud management platform 104 may comprise any of, or any combination of, an entity, server(s), platform, console, computer, etc. configurable to perform techniques for generating a model which facilitates the visualization of changes to characteristics of the cloud-based resources 110. Although the cloud management platform is illustrated as being a separate entity and computing device than the cloud-server provider(s) 102, in some examples, the cloud-service provider(s) 102 and the cloud management platform may comprise the same entity, or any number of entities configured to perform the operations described herein. Generally, the cloud management platform 104 comprises one or more components configured to obtain data from the cloud-service provider(s) 102, and generate one or more models for presenting a visual representation of the changes in the characteristics of the cloud-based resources 110. The cloud management platform 104 may comprise one or more processors 124, and computer-readable media 126. The computer-readable media may include a service application 128, a web service 130, an operations database 132, and one or more intermediate models 134.

In some examples, the service application 128 may comprise computer-readable instructions that, when executed by the processor(s) 124, perform operations for obtaining the data representative of the changes in the characteristics of the cloud-based resources 110, and storing the data in the operations database 132. The service application 128 may serve a type of aggregator of information or data. For instance, the service application 128 may periodically, or continuously, poll the storage service 122 for a new snapshot representing a state of the cloud-based resources 110 at a point in time. Additionally, the service application 128 may monitor the data queue 120 for incoming messages comprising the change notifications representing changes in the characteristics of the cloud-based resources. As the service application 128 obtains new snapshots and change notifications, the service application 128 may store or load the new snapshots and change notifications in the operations database 132, which are accessible to the web service 130.

In some examples, the web service 130 may comprise computer-readable instructions that, when executed by the processor(s) 124, perform operations for obtaining the snapshots and change notifications from the operations database 132, and employing the intermediate model(s) 134 to generate a description based at least in part on one or more of the snapshots or the change notifications. In various examples, the web service 130 may comprise a web-based API that receives service requires from the client device(s) 106. In such examples, the web service 130 may request the intermediate model(s) 134 to create the description responsive to the request.

As noted above, the web service 130 may request the one or more rules or algorithms of the intermediate model(s) 134 to generate a description as an output using the snapshots and the change notifications as inputs. The algorithms may include a set of criteria defining what characteristics of the cloud-based resources 110 included in the snapshots and change notifications are to be used for generating the description. The criteria may include a time or date range for which a representation of the cloud-based network is requested, security information, network information, intrinsic resource attributes (e.g., size, type, class, tag, etc.), cost range, service level, etc. The web service 130 may apply the algorithms using the criteria and the input data to determine or generate the descriptions. In some examples, the criteria used by the intermediate model(s) 134 may be included in a request for a description from the client device(s) 106.

The client device(s) 106 may include any type of computing device, including, but not limited to, desktop computers, server computers, web-server computers, personal computers, mobile computers, laptop computers, tablet computers, or any other sort of computing device. The client device(s) 106 may include one or more processors 136, and computer-readable media 138 which stores a presentation module 140 and one or more diagram descriptions 142.

In some examples the presentation module 140 may comprise computer-readable instructions that, when executed by the processor(s) 136, cause presentation of the diagram description(s) 142. In some examples, the diagram description(s) 142 may be generated by the intermediate model(s) 134 which provide a visual representation of the changes in the characteristics of the cloud-based resources 110.

The client device(s) 106 may further comprise one or more network interface(s) 144 (e.g., communication connections) to communicate over one or more networks, such as network(s) 108 to receive the descriptions generated by the intermediate model(s) 134. The network interface(s) 144 may communicate or send a request to the cloud management platform, such as a call to a web-based API (e.g., web service 130), to provide the descriptions generated by the intermediate model(s) 134. The request may include the criteria specifying various parameters usable by the web service 130 to create the appropriate description. The client device(s) 106 may further include one or more input/output interface(s) 146 (e.g., one or more sensors, a display, a microphone a speaker, a camera, etc.).

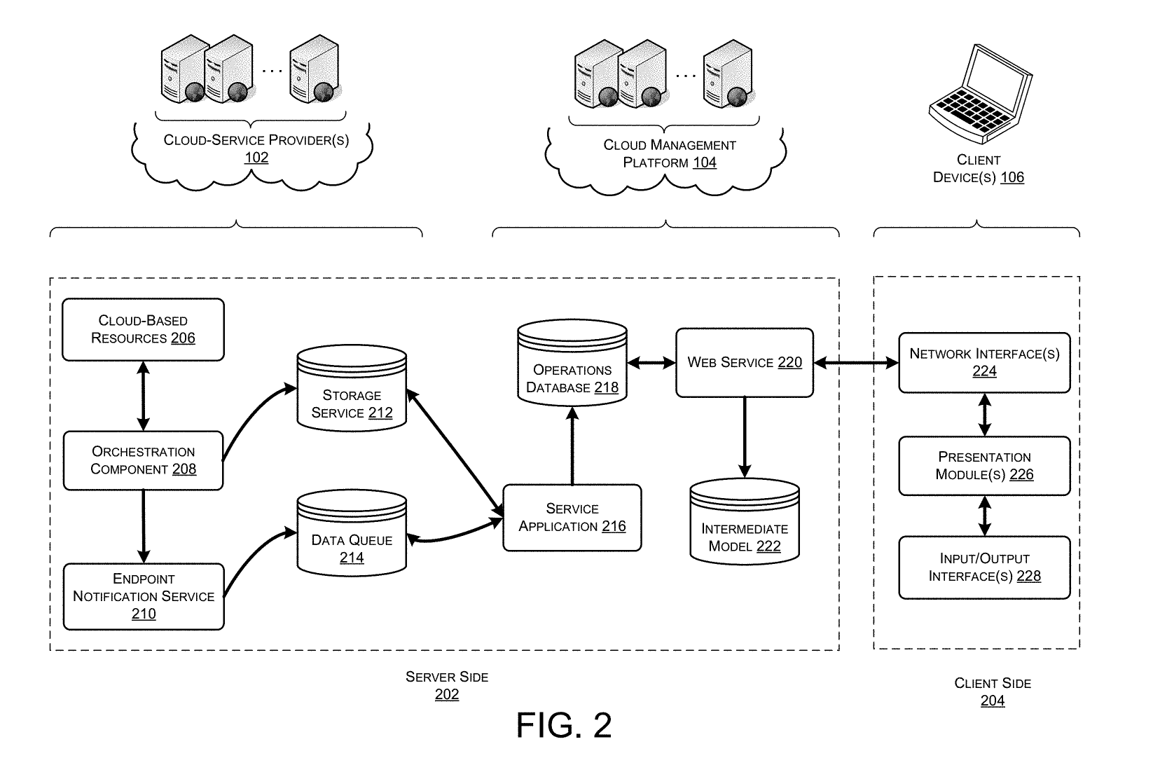

In various examples the presentation module 140 may cause the diagram description(s) 142 generated by the intermediate model(s) 134 to be presented on a display via one or more graphical user interfaces 148. In some examples, the presentation module 140 may present the diagram description(s) 142 on the graphical user interface(s) 148 along with various other selectable options for interacting with the diagram description(s) 142, as will be described in more detail with respect to FIG. 2. While the diagram description(s) 142 is illustrated as a force-directing graph in the example graphical user interface(s) 148, the diagram description(s) 142 may comprise any type of visual representation or graph, such as a tree, a box topology, a histogram, a chart, a table, or any other type of visual representation configurable to present changes in characteristics of the cloud-based resources 110 over time.

In some examples, processor(s) 112, 124, and 136 may comprise one or more of a CPU-type processing unit, a GPU-type processing unit, a HPU-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip systems (SOCs), Complex Programmable Logic Devices (CPLDs), etc.

The computer-readable media 114, 126, and 138 (as well as all other memory described herein) may include one or a combination of computer-readable media (e.g., computer storage media). Computer-readable media includes volatile and non-volatile, removable and non-removable media implemented in any method or technology for storage of information, such as computer readable instructions, data structures, program modules, or other data. Computer-readable media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer-readable media does not include communication media, such as modulated data signals and carrier waves. As such, computer-readable media is non-transitory media.

FIG. 2 illustrates example components of the example environment of FIG. 1 for obtaining data representative of changes in characteristics of a cloud-based network of resources, generating description using an intermediate model representing a visualization of the changes, and using the description to present the visualization of the changes. As illustrated, FIG. 2 is generally split into a server side 202, corresponding to cloud-service provider(s) 102 and cloud management platform 104, and a client side 204, corresponding to client device(s) 106. Generally, the client side 204 may send a request to the server side 202 for a visualization of changes in characteristics of a cloud-based network of resources, and receive a description of a diagram that presents the visualization of the changes on display of the client device(s) 106.

In some examples, the cloud-service provider(s) 102 located on the server side 202 may include cloud-based resources 206 (e.g., cloud-based resources 110) including, but not limited to, processing or computing power, storage and content delivery, database management and infrastructure, and networking management and infrastructure. The cloud-based resources 206 may partition a portion of resources to create a private cloud for individual client needs, such as a customer operating client device(s) 106. The cloud-service provider(s) 102 may periodically take snapshots of the cloud-based resources 206 of the private cloud for the customer, where the snapshots represent the state of the cloud-based resources 206 at points in time. Additionally, the cloud-service provider(s) 102 may monitor events that occur in the cloud-based resources 206 and provide change notifications representing the changes in the characteristics of the cloud-based resources 206. In various examples, the change notifications may comprise an event log, or textual list, of events and timing of when the events occur and what resources are affected by the event.

As noted above, the orchestration component 208 may include computer-readable instructions, hardware modules, or a combination of both configured to provide the data from the cloud-based resources 206 to the customers. For example, the orchestration component 208 may be employed by the cloud-service provider(s) 102 to perform various activities such as monitoring the changes in the characteristics of the cloud-based resources 206, collecting the data from other components which monitor the changes in the characteristics of the cloud-based resources 206, and/or providing the data (e.g., snapshots, change notifications, etc.) to the customers. In some examples, the orchestration component 208 may store the snapshots in one or more databases, such as storage service 212, that are accessible to the customers of the cloud-service provider(s) 102. Additionally, the orchestration component 208 may send the change notifications to an endpoint notification service 210 which is available to the customers to subscribe to. For example, as messages are received at the endpoint notification service 210 from the orchestration component 208, the endpoint notification service 210 may store, at least temporarily, the change notifications in the data queue 214. The data queue 214 may be subscribed to by the customers to receive the change notifications for their private cloud network of the cloud-based resources 206. In some examples, the storage service 212 and data queue 214 may comprise the same database, or alternatively, multiple different databases.

In some examples, the server side 202 may include the cloud management platform 104 described in FIG. 1. Generally, the cloud management platform 104 comprises one or more components configured to obtain data from the cloud-service provider(s) 102, and generate, using one or more models, a description for presenting a visual representation of the changes in the characteristics of the cloud-based resources 206. For instance, the cloud management platform 104 may include a service application(s) 216. Service application(s) 216 serve a type of aggregator of information or data. For example, the service application(s) 216 may periodically, or continuously, poll the storage service 212 for a new snapshot representing a state of the cloud-based resources 110 at a point in time. Additionally, the service application 128 may monitor the data queue 214 for incoming messages comprising the change notifications representing changes in the characteristics of the cloud-based resources. As the service application 128 obtains new snapshots and change notifications, the service application 128 may store or load the new snapshots and change notifications in the operations database 218, which are accessible to a web service 220.

The cloud management platform 104 Web service 220 may include the web service 220. Web service 220 may obtain the snapshots and the change notifications from the operations database 218 and use one or both of the snapshots and the change notifications to generate a description using one or more intermediate models 222. For example, the web service 220 may use the change notifications and the snapshots as inputs into the intermediate model 222 to create a visual representation of the changes in the characteristics of the cloud-based resources 206.

The intermediate model 222 may comprise one or more algorithms or rules configured to create a visualization (e.g., a description of a diagram or graph) of the changes in the characteristics of the cloud-based resources 206. The intermediate model 222 may use the snapshots as a baseline representation of how the cloud-based resources 206 were behaving at a point in time. Using a snapshot, the intermediate model 222 may generate a description of the cloud-based resources 206 which may be presented visually on a display. From that point, the intermediate model 222 may observe the change notifications that are fetched and provided by the web service 220 and update the baseline based on the events occurring in the cloud-based resources 206 represented in the change notifications. In this way, the intermediate model 222 may generate a description of changes in characteristics of the cloud-based resources 206 over time based on the change notifications and snapshots.

In some examples, the web service 220 may receive a request for a visual description of changes in characteristics of the cloud-based resources 206 from the client device(s) 106. For example, a presentation module 226 of the client device(s) 106 may send a request (e.g., call a web-based API) via network interface(s) 224 to the web service 220 for the description of the cloud-based resources 206. In some examples, the presentation module 226 may receive, via one or more input/output interfaces 228, parameters for the description of the cloud-based resources 206. For example, a user of the client device(s) 106 may input various parameters for the description of the changes in the characteristics of the cloud-based resources, such as a time and date range, a type of the resources to be represented in the description, security information, network information, or other information which may define or restrict the description of the changes in the characteristics of the cloud-based resources.

As described herein, the types of changes represented in the diagram description(s) 142 which were generated by the web service 130 and/or 220 using the intermediate models 134 and/or 222 and the types of resources visually depicted in the description of the changes in the characteristics of the cloud-based resources may comprise any different type of change or resource in the characteristics of the cloud-based resources 206. The changes may represent how each resource or characteristic in the cloud-based resources 206 react and change do to various events, such as a change to a particular resource or characteristic of a network based on the rules governing the network of cloud-based resources 206. For example, the intermediate model 222 may include rules or algorithms which mirror or represent the rules governing the network of cloud-based resources 206. In this way, a change shown in the change notifications may be accurately modeled and depicted by the intermediate model 222 just as the change would affect the cloud-based resources 206 itself.

In one example, the changes in the characteristics of the cloud-based resources 206 depicted in the diagram descriptions 142 which were generated by the web service 130 and/or 220 using the intermediate models 134 and/or 222 may comprise an addition or a deletion of a resource to the network of cloud-based resources. The addition or deletion of the resources may comprise the addition or deletion of virtual or physical processors or servers, databases, or network connection and infrastructure. The changes may represent how each resource in the cloud-based resources react and change due to the addition or deletion of the resource based on the rules governing the network of cloud-based resources 206. As an example, based on load balancing rules that govern the network of cloud-based resources 206, an addition of one or more virtual or physical processors may reduce the load on other instances of virtual and/or physical processors in the private network of cloud-based resources 206. As another example, the deletion of a database from the available cloud-based resources 206 may result in remaining databases increasing the amount of data stored thereupon based on rules of the cloud-based resources 206 for governing storage of data.

In various examples, the change in the characteristics of the cloud-based resources 206 represented in the diagram description(s) 142 generated by the web service 220 using the intermediate models 222 may comprise a modification of a resource of the cloud-based resources 206. For instance, a particular resource may be a storage database which has been modified by having its storage capacity increased. If the database is cheaper, geographically closer to the client, or has another desirable characteristic, then data stored in other database resources may be migrated which results in a change in the visualization of the characteristics of a network.

In other examples, the change in the characteristics of the cloud-based resources 206 represented in the diagram description(s) 142 generated by the web service 220 may comprise a change in at least one of a state, a status, or configuration data of a resource of the cloud-based network of resources. As an example, the change in the characteristics of the cloud-based resources 206 may be caused by a change to a load balancer in the network which causes a state of one or more resources to be changed, and have their respective icon positions and/or representations in a diagram changed. In one example, a resource may be represented by an icon and may have its status changed to one of a “pause resource” or a “run resource.” In some examples, the change may be represented visually on a diagram. For example, a resource whose status is changed to “pause resource” may have a dotted line surrounding the resource to show that the resource is “paused,” or a previously paused resource may be changed to a “running resource” and have its exterior line changed to a solid line.

In some instances, the change in the characteristics of the cloud-based resources 206 represented in the diagram description(s) 142 generated by the web service 220 using the intermediate models 222 may comprise a change in a price, a rate, or a cost data of a resource of the cloud-based network of resources. For example, the cost of processing or computing power associated with a particular resource may increase or decrease. Depending on the change in the cost of the processing power provided by the resource, the particular resource may perform more or less of the processing needs of the client to save money.

In various examples the change in the characteristics of the cloud-based resources 206 represented in the diagram description(s) 142 generated by the web service 220 using the intermediate models 222 may comprise a change in a relationship between a first resource of the cloud-based network of resources and a second resource of the cloud-based network of resources. For instance, the first resource may originally be included in a same virtual partition as the second resource, and protected by the same security provisions (e.g., firewall). However, if the first resource is migrated into a different subnet protected by different security provisions, the visual representation of the changes in the characteristics of the network may graphically indicated that the first resource is in a separate subnet using various graphics and diagrams.

In some instances, the change in the characteristics of the cloud-based resources 206 represented in the diagram description(s) 142 generated by the web service 220 using the intermediate models 222 may comprise a change in usage data for at least one of a resource of the cloud-based network of resources or a group of resources of the cloud-based network of resources. For example, if the processing requirements for a particular processing resource reduce, the size of the visualization of the resource may reduce to visually illustrate this change. Alternatively, a change in color, shape, or any other graphical indicator may be used to illustrate a change in usage for a particular resource.

In some instances, the change in the characteristics of the cloud-based resources 206 represented in the diagram description(s) 142 generated by the web service 220 using the intermediate models 222 may comprise a change in security data for a resource of the cloud-based network of resources. In such examples, a resource may be grouped into a first set of resources based on the first set of resources all being a part of a firewall group. However, the security data for the resource may be changed such that the resource becomes part of a different firewall group, and thus, part of a second set of resources.

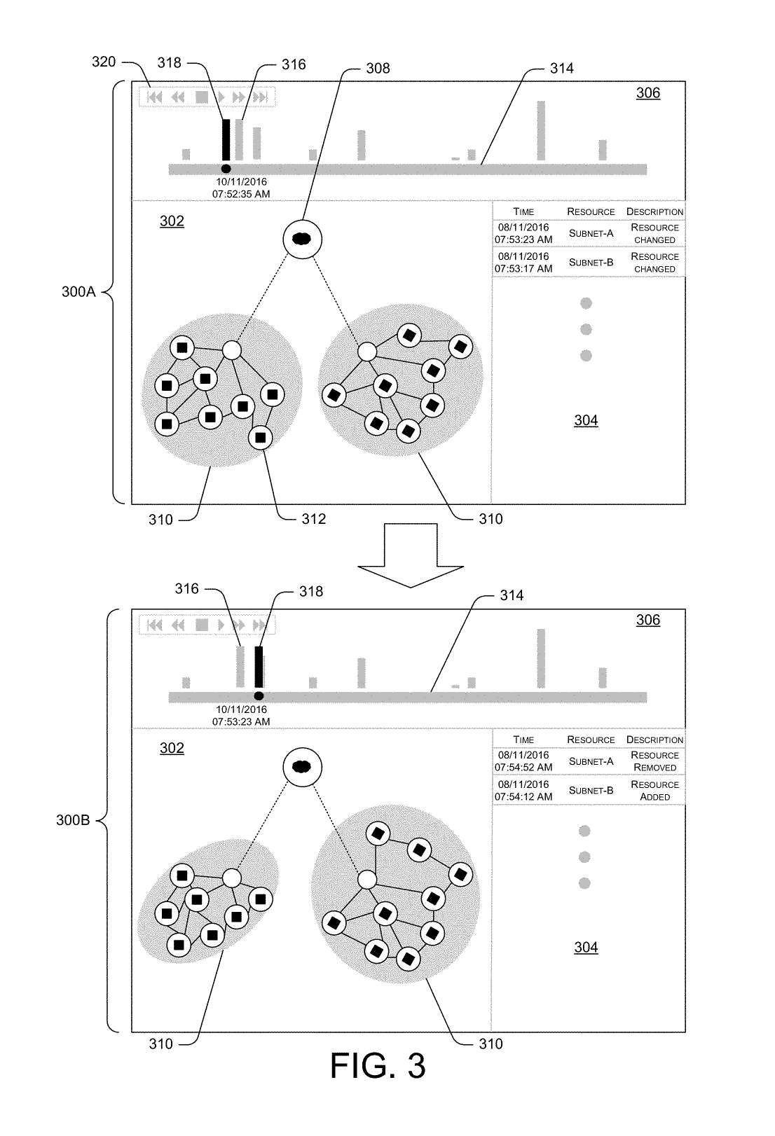

FIG. 3 illustrates an example user interface usable for presenting a visualization of changes in characteristics of changes in characteristics of a cloud-based network of resources.

As shown in FIG. 3, a graphical user interface 300A may be presented on a display of a computing device, such as client device 106. As illustrated, the graphical user interface 300A may include multiple portions including a first portion 302, a second portion 304, and a third portion 306. The first portion 302 may generally include or depict a visualization of changes in characteristics of a cloud-based network of resources. In some examples the visualization may be a force-directed graph diagram, as shown in first portion 302. However, in other examples the visualization may additionally or alternatively comprise a tree diagram, a box topology diagram, a chart, a graph, or any other type of graphical visualization configurable to depict changes in characteristics of a cloud-based network of resources.

The visualization in the first portion 302 may include a representation of a virtual private network (VPN) 308 (i.e., network container) for a particular client or customer. In some examples, a customer account may have multiple network blocks of VPNs that allow segregation of their allocated cloud-based resources. In various examples, the VPN 308 may have multiple subnets 310, illustrated as a substantially circular shape. The subnets 310 may generally comprise an assignment of a subnet of virtual addresses within the VPN 308. The subnets 310 may represent various virtual partitions, such as the virtual addresses of resources 312 which are assigned to different security groups or network groups. The resources 312 included in the subnets 310 may represent physical resources, such as databases, processors, servers, etc. In some examples, the resources may additionally or alternatively represent virtual resources, such as virtual processors. The resources 312 may be connected with each other by lines, which illustrate relationships between the resources 312, such as belonging to a same subnet 310 or another network.

As shown in graphical user interface 300A, the second portion 304 may generally include a textual log representing the visualization of the changes in the characteristics of the cloud-based network depicted in the first portion 302. The textual log may include various categories of information related to the visualization of the changes in the characteristics of the cloud-based network, such as a time at which a change occurred, a resource affected by the change, a description of the change that occurred. For example, as shown in the second portion 304, a change in the network occurred at 7:53:23 AM on Aug. 11, 2016. The change affected subnet A, and the change was a change to a resource. Thus, the changes in the characteristics of the network which are shown in the visualization in the first portion 302 are additionally represented in text in the second portion 304 as they occur in the visualization.

In some examples, the third portion 306 may include a timeline 314 which spans the length of time for which the visualization represents the changes in the characteristics of the network. Along the timeline 314 are events 316 corresponding to the changes shown in the visualization in the first portion 302, and the text log in the second portion 304. Additionally, along the timeline 314, an indicator 318 may illustrate the point in time at which the visualization of the changes is illustrating in the period of time. As the visualization progresses through time, the indicator 318 may move along the timeline 314 and pass each of the events 316.

In some examples, various selectable controls 320 may be presented in one of the multiple portions, such as the third portion 306. The controls 320 may provide various functionality for controlling the visualization of the changes in the characteristics of the network, such as play, pause, fast forward, rewind, skip forward, and skip back operations.

FIG. 3A further includes a graphical user interface 300 which may be presented on a display of a computing device, such as client device 106. The graphical user interface 300B may correspond to graphical user interface 300A, but at a different point in time. For example, the indicator may have progressed in time along the timeline 314 and passed through one or more of the events 316. As shown in third portion 306, the indicator 318 passed through two events 316 compared to graphical user interface 300A. Further, the second portion 304 demonstrates that the events 316 correspond to subnet A having a resource removed, and subnet B having a resource added. Further, first portion 302 illustrates the resources having been removed from subnet A and added to subnet B. Additionally, the subnets 310 demonstrate how subnet A has shrunk after losing a resource, whereas subnet B has expanded after adding a resource.

Thus, graphical user interfaces 300A and 300B illustrate an example of how the visualization of the changes in the characteristics of the cloud-based network may be presented on a display associated with a client device based on a description of a diagram provided generated based on an intermediate model.

In some examples, the graphical user interfaces 300A and 300B may be configured to present visualizations of changes based on the resource or characteristics desired. For instance, the visualization of the changes in the characteristics of the cloud-based network may be filtered to only represent firewall relationships, database servers, or processors individually, rather than all resources or instances of a network. Additionally, the graphical user interfaces 300A and 300B may be used to “zoom in” or “zoom out” to focus on various portions of a cloud-based network, rather than the entire network for a particular customer.

In some examples, the graphical user interfaces 300A and 300B may provide controls for operations or actions that may be taken, or automatically perform various actions on the networks. For instance, some tasks or actions that may be taken using the graphical user interfaces 300A and 300B may include applying security configuration changes based on the visualization data, taking actions on groups of resources (e.g., applying patches to all resources in a group), and/or applying security changes to groups of resources.

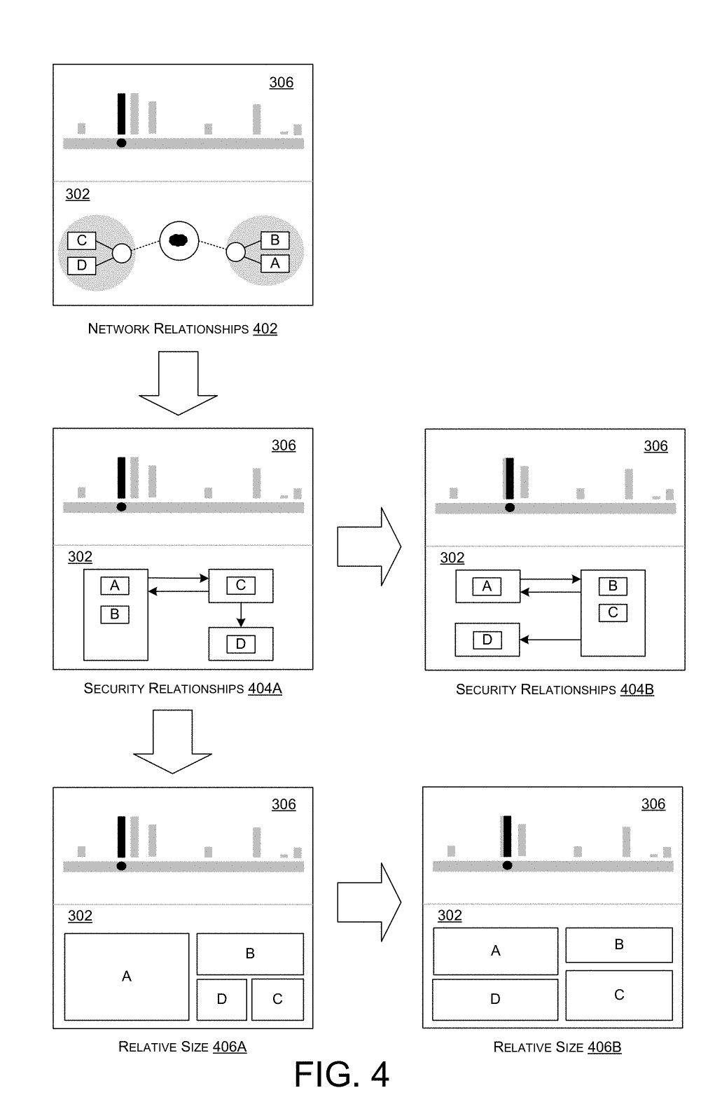

FIG. 4 illustrates example user interfaces usable for presenting visualizations of changes in several different characteristics of a cloud-based network of resources.

As shown in FIG. 4, graphical user interfaces are presented depicting various characteristics of a cloud-based network of resources, including network relationships 402. Similar to the graphical user interfaces of FIG. 3 (e.g., 300A and 300B), the graphical user interface presenting the network relationships 402 may include a visualization of a private network for a particular client or customer and two subnets which may represent virtual partitions, such as the virtual addresses of instances or resources of the cloud-based network. As depicted a first subnet includes resources A and B, and a second subnet includes resources C and D. The graphical user interfaces described in FIG. 4 may be presented on a display (e.g., input/output interface(s) 146/228) of a computing device (e.g., computing device(s) 106). The graphical user interfaces, and the changes depicted therein, may be presented based on the diagram description(s) 142 which were generated by web service 130/220 based on intermediate model(s) 134.

In some instances, the graphical user interface may include controls that are selectable to change a view of the resources to depict characteristics other than the network relationships 402. For example, a control may be selected to cause the resources A, B, C, and D to be presented according to characteristics such as security relationships 404A. Security relationships 404A may comprise firewall rulesets which are applied to groups of the resources. In one example, the resources that have the same firewall rulesets applied to them may be grouped in boxes in the format of a box diagram. In the illustrated example, resources A and B are grouped together in the box diagram as they belong to the same firewall ruleset, whereas resources C and D are grouped into their own individual firewall rulesets.

Similar to the techniques described in FIG. 3, the graphical user interface presenting the security relationships 404A may depict the security characteristics of resources A, B, C, and D changing over time. For instance, the graphical user interface may depict security relationships 404B at a different point in time than security relationships 404A. Security relationships 404B may illustrate changes in the characteristics of the cloud-based network, such as changes in the firewall rulesets as applied to the resources. As shown in security relationships 404B, the resources have had changed over time. For example, resources B and C are now grouped according to the same firewall ruleset, and resources A and D are now in individual groups based on their firewall ruleset. This change shown in the security relationships 404B may indicate an event, such as an administrator changing various firewall rulesets.

In some examples, the graphical user interface may further include controls which are selectable to change the view of the resources to illustrate the relative size 406A of the resources. As shown in the relative size 406A depiction, a histogram visualization may demonstrate that the size of resource A is much larger than that of B, C, and D, where “size” is a property of the resources A, B, C, and D. In various examples, the graphical user interface may present relative size 406B of the resources A, B, C, and D at a different point in time than that depicted by relative size 406A. For example, responsive to an event that changes characteristics of the cloud-based network, the size of resources A, B, C, and D are adjusted as the characteristics of the cloud-based network of resources are changed in time.

### Example Processes

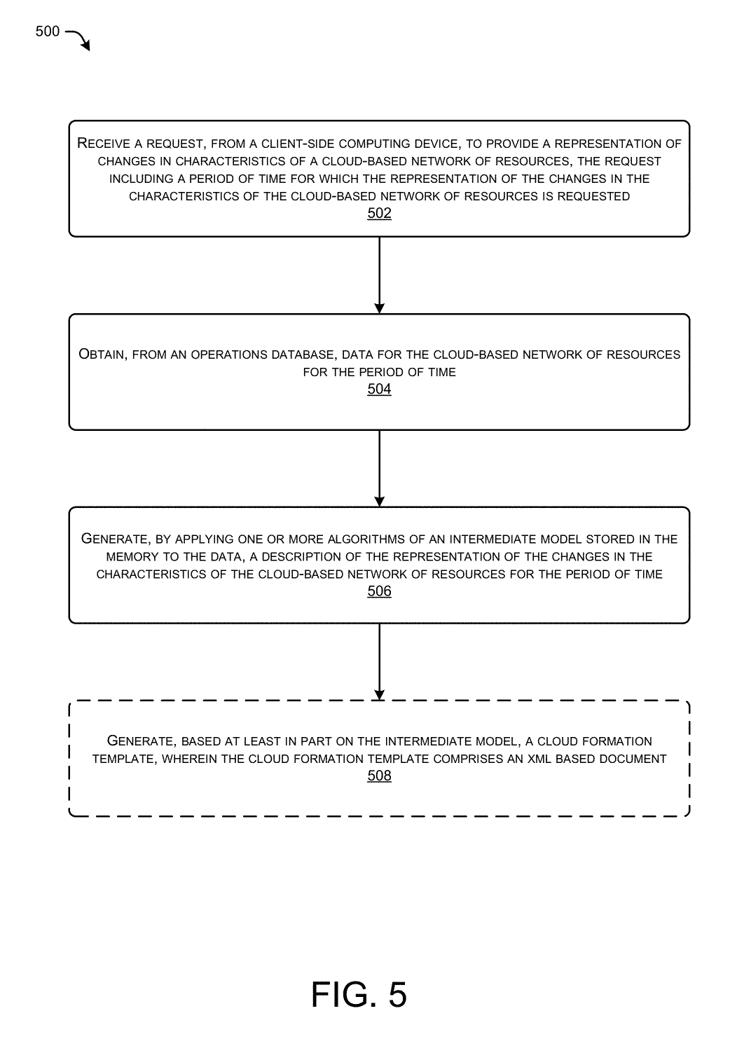

The processes described in FIGS. 5-7 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 5 illustrates an example process 500 to receive a request to provide a representation of changes in characteristics of a cloud-based network of resources, and generating a representation of the changes in the characteristics of the cloud-based network.

At 502, a web service (e.g., web service 130, web service 220, etc.) receives a request, from a client side computing device, to provide a representation of changes in characteristics of a cloud-based network of resources. In some examples, the request may include a period of time for which the representation of the changes in the characteristics of the cloud-based network of resources is requested, or any other criteria or parameters which may be used to determine the representation of the changes in the characteristics of the cloud-based network.

At 504, the web service may obtain, from an operations database (e.g., operations database 132, operations database 218, etc.), data for the cloud-based network of resources for the period of time indicated in the request. In some examples, the data may comprise a snapshot of the characteristics of the cloud-based network of resources at a particular point in time, and/or a list of notifications indicating changes in the characteristics of the cloud-based network of resources subsequent to the particular point in time. In various examples, obtaining the data for the cloud-based network of resources from the operations database comprises, in response to receiving the request from the client-side computing device, sending a service request to the operations database for the data, the service request indicating the period of time for which the data is requested.

At 506, the web service may generate, by applying one or more algorithms of an intermediate model (e.g., intermediate model(s) 134, intermediate model 222, etc.) stored in the memory to the data, a description of the representation of the changes in the characteristics of the cloud-based network of resources for the period of time. In various examples, the intermediate model may generate a description of a diagram that, when presented by the client-side computing device on a screen, illustrates a chronological visualization of the changes in the characteristics of the cloud-based network of resources over the period of time. In some instances, the changes in the characteristics of the cloud-based network of resources comprises at least one of: addition of a resource of the cloud-based network of resources; deletion of a resource of the cloud-based network of resources; modification of a resource of the cloud-based network of resources; a change in at least one of a state, a status, or configuration data of a resource of the cloud-based network of resources; a change in a price, a rate, or a cost data of a resource of the cloud-based network of resources; a change in a relationship between a first resource of the cloud-based network of resources and a second resource of the cloud-based network of resources; a change in usage data for at least one of a resource of the cloud-based network of resources or a group of resources of the cloud-based network of resources; or a change in security data for a resource of the cloud-based network of resources.

In various examples, example process may further include operation 508. At 508, the web service may further generate, based at least in part on the intermediate model, a cloud formation template. In some instances, the cloud formation template comprises an Extensible Markup Language (XML), or equivalent technology based document (e.g., JavaScript Object Notation (JSON), YAML, etc.).

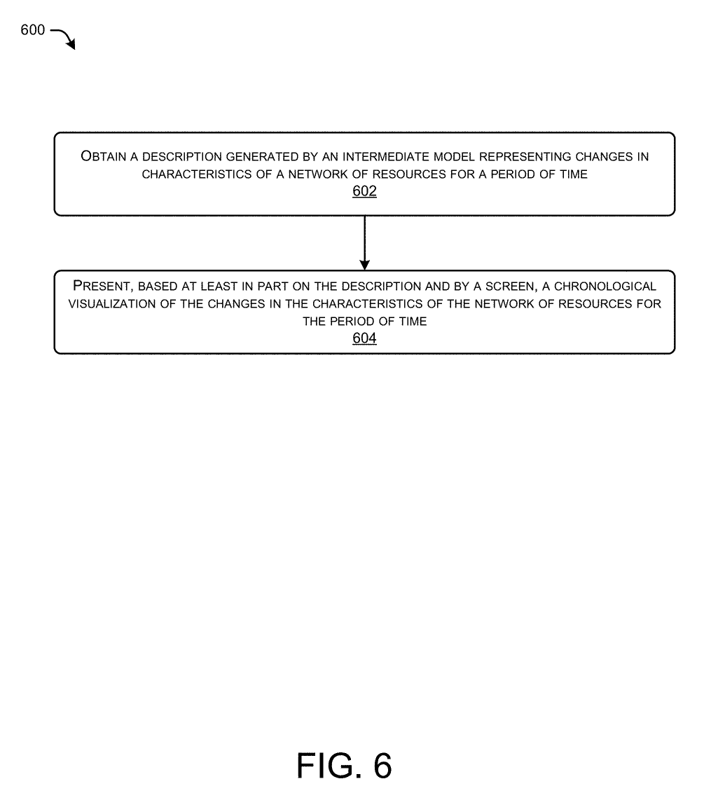

FIG. 6 illustrates an example process 600 to obtain a description representing changes in characteristics of a network of resources for a period of time, and presenting the description of the changes generated by the intermediate model.

At 602, one or more modules of a client computing device (e.g., presentation module 140, presentation module 226, etc.) may obtain a description generated by an intermediate model representing changes in characteristics of a network of resources for a period of time. In some instances, obtaining the description may comprise sending a request to a web-based application program interface (API) to generate the description, the request including an indication of the period of time for which the representation generated by the intermediate model is to represent the changes in the characteristics of the network of resources, and receiving the description from the web-based API.

At 604, the one or more modules of the client computing device may present, based at least in part on the description and by a screen associated with the client device (e.g., input/output interface(s) 146, input/output interface(s) 228, etc.), a chronological visualization of the changes in the characteristics of the network of resources for the period of time. In some examples, presenting the chronological visualization of the changes in the characteristics of the network of resources for the period of time comprises presenting a diagram representing the network of resources, receiving a selection for playback of the chronological visualization of the changes in the characteristics of the network of resources for the period of time, and causing the diagram representing the network of resources to be visually manipulated according to the changes in the characteristics of the network of resources for the period of time.

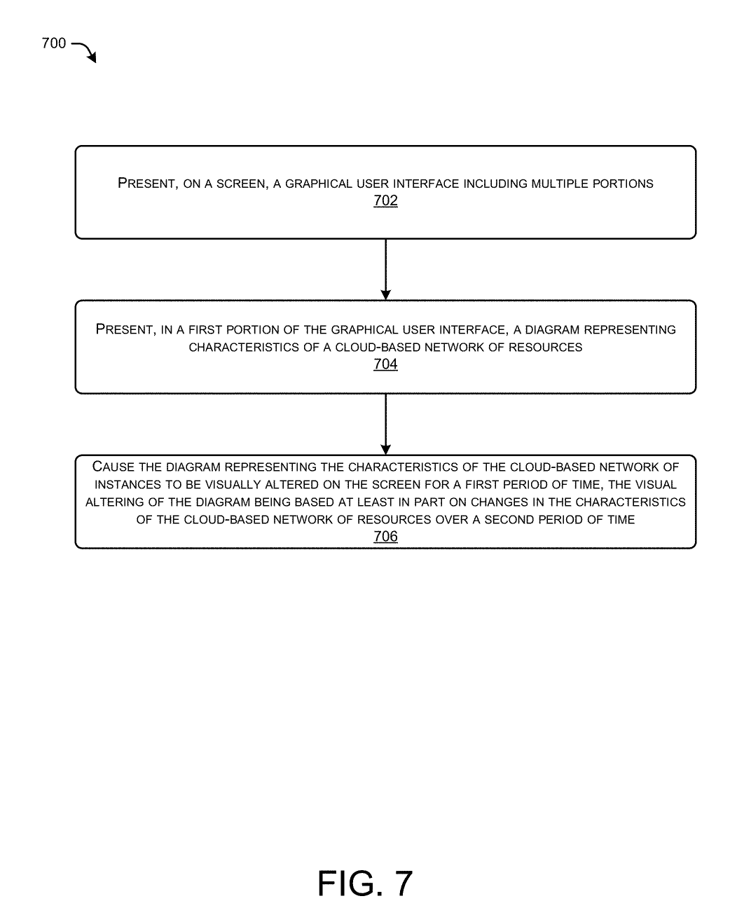

FIG. 7 illustrates an example process 700 to present a diagram representing characteristics of a cloud-based network of resources in a graphical user interface, and cause the diagram to be visually altered based on changes in the characteristics of the cloud-based network of resources.

At 702, one or more components (e.g., presentation module 140, presentation module 226, etc.) of a client computing device may present, on a screen associated with the client computing device, a graphical user interface including multiple portions.

At 704, the one or more component may present, in a first portion of the multiple portions of the graphical user interface, a diagram representing characteristics of a cloud-based network of resources. In various examples, presenting the diagram may comprise presenting a first graphical indicator which graphically represents a first subnet of the cloud-based network of resources, presenting one or more graphical relationship indicators which graphically indicate that the first subnet includes a first resource and a second resource of the cloud-based network of resources, presenting a second graphical indicator associated with the first resource, and presenting a third graphical indicator associated with the second resource.

At 706, the one or more components may cause the diagram representing the characteristics of the cloud-based network of resources to be visually altered on the screen for a first period of time, the visual altering of the diagram being based at least in part on changes in the characteristics of the cloud-based network of resources over a second period of time. in some instances, causing the diagram to be visually altered for the first period of time includes detecting a particular change in the characteristics of the cloud-based network of resources associated with the first subnet during the second period of time, and based at least in part on detecting the particular change, causing a visual change in a feature of the first graphical indicator. In various examples, causing the diagram to be visually altered for the first period of time includes detecting a particular change associated with at least one of the first resource or the second resource during the second period of time, and based at least in part on detecting the particular change, causing a visual change in a feature of at least one of the second graphical indicator or the third graphical indicator. In some instances, the diagram may comprise at least one of a force-directed graph diagram, a tree diagram, a box topology diagram, a chart, or a graph.

### Example Clauses

A: A system comprising: connections configured to communicate over a network; one or more processors; and memory having computer-executable instructions stored thereupon which, when executed by the one or more processors, cause the one or more processors to: receive a request, from a client-side computing device, to provide a representation of changes in characteristics of a cloud-based network of resources, the request including a period of time for which the representation of the changes in the characteristics of the cloud-based network of resources is requested; obtain, from an operations database, data for the cloud-based network of resources for the period of time; and generate, by applying one or more algorithms of an intermediate model stored in the memory to the data, a description of the representation of the changes in the characteristics of the cloud-based network of resources for the period of time.

B: A system as paragraph A recites, further comprising: a description of a diagram that, when presented by the client-side computing device on a screen, illustrates a chronological visualization of the changes in the characteristics of the cloud-based network of resources over the period of time.

C: A system as paragraph B recites, wherein the description of the representation of the changes in the characteristics of the cloud-based network of resources is configured to be interacted with by a playback tool, the interaction comprising: receiving a selection of a point in time during the period of time at which to begin playback of the chronological visualization of the changes in the characteristics of the cloud-based network of resources; and in response to receiving the selection, displaying the chronological visualization of the changes in the characteristics of the cloud-based network of resources for the period of time subsequent to the point in time.

D: A system as any of paragraphs A-C recites, wherein the changes in the characteristics of the cloud-based network of resources comprise at least one of: addition of a resource of the cloud-based network of resources; deletion of a resource of the cloud-based network of resources; modification of a resource of the cloud-based network of resources; a change in at least one of a state, a status, or configuration data of a resource of the cloud-based network of resources; a change in a price, a rate, or a cost data of a resource of the cloud-based network of resources; a change in a relationship between a first resource of the cloud-based network of resources and a second resource of the cloud-based network of resources; a change in usage data for at least one of a resource of the cloud-based network of resources or a group of resources of the cloud-based network of resources; or a change in security data for a resource of the cloud-based network of resources.

E: A system as any of paragraphs A-D recites, wherein obtaining the data for the cloud-based network of resources from the operations database comprises: in response to receiving the request from the client-side computing device, sending a service request to the operations database for the data, the service request indicating the period of time for which the data is requested.

F: A system as any of paragraphs A-E recites, wherein the data comprises: a snapshot of the characteristics of the cloud-based network of resources at a particular point in time; and a list of notifications indicating changes in the characteristics of the cloud-based network of resources subsequent to the particular point in time; and wherein generating the description of the representation of the changes in the characteristics of the cloud-based network of resources for the period of time comprises: determining a baseline representation of the characteristics of the cloud-based network of resources based on the snapshot of the characteristics; and determining changes in the baseline representation of the characteristics for the period of time based at least in part on the list of notifications.

G: A system as any of paragraphs A-F recites, the operations further comprising: generating, based at least in part on the intermediate model, a cloud formation template, wherein the cloud formation template comprises a xml based document or an equivalent technology.

H: A computer-implemented method comprising: obtaining a description generated by an intermediate model representing changes in characteristics of a network of resources for a period of time; and presenting, based at least in part on the description and by a screen, a chronological visualization of the changes in the characteristics of the network of resources for the period of time.

I: A computer-implemented method as paragraph H recites, wherein obtaining the description comprises: sending a request to a web-based application program interface (API) to generate the description, the request including an indication of the period of time for which the description is to represent the changes in the characteristics of the network of resources; and receiving the description from the web-based API.

J: A computer-implemented method as paragraph H and/or I recites, wherein presenting the chronological visualization of the changes in the characteristics of the network of resources for the period of time comprises: presenting a diagram representing the network of resources; receiving a selection for playback of the chronological visualization of the changes in the characteristics of the network of resources for the period of time; and causing the diagram representing the network of resources to be visually manipulated according to the changes in the characteristics of the network of resources for the period of time.

K: A computer-implemented method as any of paragraphs H-J recites, wherein presenting the chronological visualization of the changes in the characteristics of the network of resources for the period of time comprises: presenting a diagram representing the network of resources; receiving a selection at a point in time during the period of time at which to begin playback of the chronological visualization of the changes in the characteristics of the network of resources; and causing the diagram representing the network of resources to be visually manipulated according to the changes in the characteristics of the network of resources for the period of time subsequent to the point in time.

L: A computer-implemented method as any of paragraphs H-K recites, wherein the changes in the characteristics of the network of resources comprises at least one of: addition of a resource of the network of resources; deletion of a resource of the network of resources; modification of a resource of the cloud-based network of resources; a change in at least one of a state, a status, or configuration data of a resource of the cloud-based network of resources; a change in at least one of a price, a rate, or a cost data of a resource of the cloud-based network of resources; a change in a relationship between a first resource of the network of resources and a second resource of the cloud-based network of resources; a change in usage data for at least one of a resource of the network of resources or a group of resources of the cloud-based network of resources; or a change in security data for a resource of the network of resources.

M: A computer-implemented method comprising: presenting, on a screen, a graphical user interface including multiple portions; presenting, in a first portion of the multiple portions of the graphical user interface, a diagram representing characteristics of a cloud-based network of resources; and causing the diagram representing the characteristics of the cloud-based network of resources to be visually altered on the screen for a first period of time, the visual altering of the diagram being based at least in part on changes in the characteristics of the cloud-based network of resources over a second period of time.

N: A computer-implemented method as paragraph M recites, further comprising: presenting a first graphical indicator which graphically represents a first subnet of the cloud-based network of resources; presenting one or more graphical relationship indicators which graphically indicate that the first subnet includes a first resource and a second resource of the cloud-based network of resources; presenting a second graphical indicator associated with the first resource; and presenting a third graphical indicator associated with the second resource.

O: A computer-implemented method as paragraph N recites, further comprising: detecting a particular change in the characteristics of the cloud-based network of resources associated with the first subnet during the second period of time; and based at least in part on detecting the particular change, causing a visual change in a feature of the first graphical indicator.

P: A computer-implemented method as paragraph N and/or 0 recites, further comprising: detecting a particular change associated with at least one of the first resource or the second resource during the second period of time; and based at least in part on detecting the particular change, causing a visual change in a feature of at least one of the second graphical indicator or the third graphical indicator.

Q: A computer-implemented method as any of paragraphs M-P recites, further comprising: presenting, in a second portion of the multiple portions of the graphical user interface, a textual log representing the changes in the characteristics of the cloud-based network of resources over the second period of time.

R: A computer-implemented method as any of paragraphs M-Q recites, further comprising: presenting, in a third portion of the graphical user interface, a control that is selectively operable to receive a selection of a point in time during the second period of time; and causing the diagram representing the characteristics of the cloud-based network of resources to be visually altered on the screen for the second period of time subsequent to the point in time.

S: A computer-implemented method as any of paragraphs M-R recites, wherein the diagram representing the characteristics of the cloud-based network of resources comprises at least one of: a force-directed graph diagram; a tree diagram; a box topology diagram; a chart; or a graph.

T: A computer-implemented method as any of paragraphs M-S recites, wherein the changes in the characteristics of the cloud-based network of resources comprise at least one of: addition of a resource of the cloud-based network of resources; deletion of a resource of the cloud-based network of resources; modification of a resource of the cloud-based network of resources; a change in at least one of a state, a status, or a configuration data of a resource of the cloud-based network of resources; a change in at least one of a price, a rate, or a cost data of a resource of the cloud-based network of resources; a change in a relationship between a first resource of the cloud-based network of resources and a second resource of the cloud-based network of resources; a change in usage data for at least one of n resource of the cloud-based network of resources or a group of resources of the cloud-based network of resources; or a change in security data for a resource of the cloud-based network of resources.

U: A computer-readable medium including computer executable instructions to configure a computer to perform a computer-implemented method as any of paragraphs H-L.

V: A system comprising: one or more processors; and a computer-readable medium configured to be coupled to the one or more processors, the computer-readable medium including processor-executable instructions to configure a computer to perform a computer-implemented method as any of paragraphs H-L recite.

W: A system comprising: means for obtaining a description generated by an intermediate model representing changes in characteristics of a network of resources for a period of time; and means for presenting, based at least in part on the description and by a screen, a chronological visualization of the changes in the characteristics of the network of resources for the period of time.

X: A system as paragraph W recites, further comprising means for sending a request to a web-based application program interface (API) to generate the description, the request including an indication of the period of time for which the description is to represent the changes in the characteristics of the network of resources; and means for receiving the description from the web-based API; optionally, wherein the means for obtaining the description comprises the means for sending the request and/or the means for receiving the description from the web-based API.

Y: A system as paragraph W and/or X recites, further comprising: means for presenting a diagram representing the network of resources; means for receiving a selection for playback of the chronological visualization of the changes in the characteristics of the network of resources for the period of time; and means for causing the diagram representing the network of resources to be visually manipulated according to the changes in the characteristics of the network of resources for the period of time; optionally, wherein the presenting the chronological visualization of the changes in the characteristics of the network of resources for the period of time comprises the means for presenting the diagram representing the network of resources and/or means for receiving the selection for playback of the chronological visualization.

Z: A system as any of paragraphs W-Y recites, further comprising: means for presenting a diagram representing the network of resources; means for receiving a selection at a point in time during the period of time at which to begin playback of the chronological visualization of the changes in the characteristics of the network of resources; and means for causing the diagram representing the network of resources to be visually manipulated according to the changes in the characteristics of the network of resources for the period of time subsequent to the point in time; optionally, wherein presenting the chronological visualization of the changes in the characteristics of the network of resources for the period of time comprises at least one of the means for presenting the diagram representing the network of resources, the means for receiving the selection, and/or the means for causing the diagram representing the network of resources to be visually manipulated.

AA: A system as any of paragraphs W-Z recites, wherein the changes in the characteristics of the network of resources comprises at least one of: addition of a resource of the network of resources; deletion of a resource of the network of resources; modification of a resource of the cloud-based network of resources; a change in at least one of a state, a status, or configuration data of a resource of the cloud-based network of resources; a change in at least one of a price, a rate, or a cost data of a resource of the cloud-based network of resources; a change in a relationship between a first resource of the network of resources and a second resource of the cloud-based network of resources; a change in usage data for at least one of a resource of the network of resources or a group of resources of the cloud-based network of resources; or a change in security data for a resource of the network of resources.

AB: A computer-readable medium including computer executable instructions to configure a computer to perform a computer-implemented method as any of paragraphs M-T recite.

AC: A system comprising: one or more processors; and a computer-readable medium configured to be coupled to the one or more processors, the computer-readable medium including processor-executable instructions to configure a computer to perform a computer-implemented method as any of paragraphs M-T recite.

AD: A system comprising: means for presenting, on a screen, a graphical user interface including multiple portions; means for presenting, in a first portion of the multiple portions of the graphical user interface, a diagram representing characteristics of a cloud-based network of resources; and means for causing the diagram representing the characteristics of the cloud-based network of resources to be visually altered on the screen for a first period of time, the visual altering of the diagram being based at least in part on changes in the characteristics of the cloud-based network of resources over a second period of time.

AE: A system as paragraph AD recites, further comprising: means for presenting a first graphical indicator which graphically represents a first subnet of the cloud-based network of resources; means for presenting one or more graphical relationship indicators which graphically indicate that the first subnet includes a first resource and a second resource of the cloud-based network of resources; presenting a second graphical indicator associated with the first resource; and presenting a third graphical indicator associated with the second resource.

AF: A system as paragraph AE recites, further comprising: means for detecting a particular change in the characteristics of the cloud-based network of resources associated with the first subnet during the second period of time; and based at least in part on detecting the particular change, means for causing a visual change in a feature of the first graphical indicator.

AG: A system as paragraph AE and/or AF recites, further comprising: means for detecting a particular change associated with at least one of the first resource or the second resource during the second period of time; and based at least in part on detecting the particular change, means for causing a visual change in a feature of at least one of the second graphical indicator or the third graphical indicator.

AH: A system as any of paragraphs AD-AG recites, further comprising: means for presenting, in a second portion of the multiple portions of the graphical user interface, a textual log representing the changes in the characteristics of the cloud-based network of resources over the second period of time.

AI: A system as any of paragraphs AD-AH recites, further comprising: means for presenting, in a third portion of the graphical user interface, a control that is selectively operable to receive a selection of a point in time during the second period of time; and means for causing the diagram representing the characteristics of the cloud-based network of resources to be visually altered on the screen for the second period of time subsequent to the point in time.

AJ: A system as any of paragraphs AD-AI recites, wherein the diagram representing the characteristics of the cloud-based network of resources comprises at least one of: a force-directed graph diagram; a tree diagram; a box topology diagram; a chart; or a graph.

AK: A system as any of paragraphs AD-AJ recites, wherein the changes in the characteristics of the cloud-based network of resources comprise at least one of: addition of a resource of the cloud-based network of resources; deletion of a resource of the cloud-based network of resources; modification of a resource of the cloud-based network of resources; a change in at least one of a state, a status, or a configuration data of a resource of the cloud-based network of resources; a change in at least one of a price, a rate, or a cost data of a resource of the cloud-based network of resources; a change in a relationship between a first resource of the cloud-based network of resources and a second resource of the cloud-based network of resources; a change in usage data for at least one of n resource of the cloud-based network of resources or a group of resources of the cloud-based network of resources; or a change in security data for a resource of the cloud-based network of resources.

AL: A method comprising: receiving a request, from a client-side computing device, to provide a representation of changes in characteristics of a cloud-based network of resources, the request including a period of time for which the representation of the changes in the characteristics of the cloud-based network of resources is requested; obtaining, from an operations database, data for the cloud-based network of resources for the period of time; and generating, by applying one or more algorithms of an intermediate model stored in the memory to the data, a description of the representation of the changes in the characteristics of the cloud-based network of resources for the period of time.

AM: A method as paragraph AL recites, further comprising: presenting a description of a diagram that, when presented by the client-side computing device on a screen, illustrates a chronological visualization of the changes in the characteristics of the cloud-based network of resources over the period of time.

AN: A method as paragraph AM recites, wherein the description of the representation of the changes in the characteristics of the cloud-based network of resources is configured to be interacted with by a playback tool, the interaction comprising: receiving a selection of a point in time during the period of time at which to begin playback of the chronological visualization of the changes in the characteristics of the cloud-based network of resources; and in response to receiving the selection, displaying the chronological visualization of the changes in the characteristics of the cloud-based network of resources for the period of time subsequent to the point in time.

AO: A method as any of paragraphs AL-AN recite, wherein the changes in the characteristics of the cloud-based network of resources comprise at least one of: addition of a resource of the cloud-based network of resources; deletion of a resource of the cloud-based network of resources; modification of a resource of the cloud-based network of resources; a change in at least one of a state, a status, or configuration data of a resource of the cloud-based network of resources; a change in a price, a rate, or a cost data of a resource of the cloud-based network of resources; a change in a relationship between a first resource of the cloud-based network of resources and a second resource of the cloud-based network of resources; a change in usage data for at least one of a resource of the cloud-based network of resources or a group of resources of the cloud-based network of resources; or a change in security data for a resource of the cloud-based network of resources.

AP: A method as any of paragraphs AL-AO recites, wherein obtaining the data for the cloud-based network of resources from the operations database comprises: in response to receiving the request from the client-side computing device, sending a service request to the operations database for the data, the service request indicating the period of time for which the data is requested.

AQ: A method as any of paragraphs AL-AP recites, wherein the data comprises: a snapshot of the characteristics of the cloud-based network of resources at a particular point in time; and a list of notifications indicating changes in the characteristics of the cloud-based network of resources subsequent to the particular point in time; and wherein generating the description of the representation of the changes in the characteristics of the cloud-based network of resources for the period of time comprises: determining a baseline representation of the characteristics of the cloud-based network of resources based on the snapshot of the characteristics; and determining changes in the baseline representation of the characteristics for the period of time based at least in part on the list of notifications.

AR: A method as any of paragraphs AL-AQ recites, further comprising: generating, based at least in part on the intermediate model, a cloud formation template, wherein the cloud formation template comprises a xml based document or an equivalent technology.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

All of the methods and processes described above can be embodied in, and fully automated via, software code modules executed by one or more general purpose computers or processors. The code modules can be stored in any type of computer-readable storage medium or other computer storage device. Some or all of the methods can alternatively be embodied in specialized computer hardware.

Conditional language such as, among others, “can,” “could,” “might” or “can,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions can be deleted, or executed out of order from that shown or discussed, including substantially synchronously or in reverse order, depending on the functionality involved as would be understood by those skilled in the art. It should be emphasized that many variations and modifications can be made to the above-described examples, the elements of which are to be understood as being among other acceptable examples. All such modifications and variations are intended to be included herein within the scope of this disclosure and protected by the following claims.

What is claimed is:

1. A system comprising:
connections configured to communicate over a network;
one or more processors; and
memory having computer-executable instructions stored thereupon which, when executed by the one or more processors, cause the one or more processors to:
receive a request, from a client-side computing device, to provide a representation of changes in characteristics of a cloud-based network of resources, the request including a period of time for which the representation of the changes in the characteristics of the cloud-based network of resources is requested;
obtain, from an operations database, data for the cloud-based network of resources for the period of time; and
generate, by applying one or more algorithms of an intermediate model stored in the memory to the data, a description of the representation of the changes in the characteristics of the cloud-based network of resources for the period of time.

2. A system as claim 1 recites, further comprising:
a description of a diagram that, when presented by the client-side computing device on a screen, illustrates a chronological visualization of the changes in the characteristics of the cloud-based network of resources over the period of time.

3. A system as claim 2 recites, wherein the description of the representation of the changes in the characteristics of the cloud-based network of resources is configured to be interacted with by a playback tool, the interaction comprising:
receiving a selection of a point in time during the period of time at which to begin playback of the chronological visualization of the changes in the characteristics of the cloud-based network of resources; and
in response to receiving the selection, displaying the chronological visualization of the changes in the characteristics of the cloud-based network of resources for the period of time subsequent to the point in time.

4. A system as claim 1 recites, wherein the changes in the characteristics of the cloud-based network of resources comprise at least one of:
addition of a resource of the cloud-based network of resources;
deletion of a resource of the cloud-based network of resources;
modification of a resource of the cloud-based network of resources;
a change in at least one of a state, a status, or configuration data of a resource of the cloud-based network of resources;
a change in a price, a rate, or a cost data of a resource of the cloud-based network of resources;
a change in a relationship between a first resource of the cloud-based network of resources and a second resource of the cloud-based network of resources;
a change in usage data for at least one of a resource of the cloud-based network of resources or a group of resources of the cloud-based network of resources; or
a change in security data for a resource of the cloud-based network of resources.

5. A system as claim 1 recites, wherein obtaining the data for the cloud-based network of resources from the operations database comprises:
in response to receiving the request from the client-side computing device, sending a service request to the operations database for the data, the service request indicating the period of time for which the data is requested.

6. A system as claim 1 recites, wherein the data comprises:
a snapshot of the characteristics of the cloud-based network of resources at a particular point in time; and
a list of notifications indicating changes in the characteristics of the cloud-based network of resources subsequent to the particular point in time; and
wherein generating the description of the representation of the changes in the characteristics of the cloud-based network of resources for the period of time comprises:
determining a baseline representation of the characteristics of the cloud-based network of resources based on the snapshot of the characteristics; and
determining changes in the baseline representation of the characteristics for the period of time based at least in part on the list of notifications.

7. A system as claim 1 recites, the operations further comprising:
generating, based at least in part on the intermediate model, a cloud formation template, wherein the cloud formation template comprises a xml based document or an equivalent technology.

8. A computer-implemented method comprising:
obtaining a description generated by an intermediate model representing changes in characteristics of a network of resources for a period of time; and
presenting, based at least in part on the description and by a screen, a chronological visualization of the changes in the characteristics of the network of resources for the period of time.

9. A computer-implemented method as claim 8 recites, wherein obtaining the description comprises:
sending a request to a web-based application program interface (API) to generate the description, the request including an indication of the period of time for which the description is to represent the changes in the characteristics of the network of resources; and
receiving the description from the web-based API.

10. A computer-implemented method as claim 8 recites, wherein presenting the chronological visualization of the changes in the characteristics of the network of resources for the period of time comprises:
presenting a diagram representing the network of resources;
receiving a selection for playback of the chronological visualization of the changes in the characteristics of the network of resources for the period of time; and
causing the diagram representing the network of resources to be visually manipulated according to the changes in the characteristics of the network of resources for the period of time.

11. A computer-implemented method as claim 8 recites, wherein presenting the chronological visualization of the changes in the characteristics of the network of resources for the period of time comprises:
presenting a diagram representing the network of resources;
receiving a selection at a point in time during the period of time at which to begin playback of the chronological visualization of the changes in the characteristics of the network of resources; and
causing the diagram representing the network of resources to be visually manipulated according to the changes in the characteristics of the network of resources for the period of time subsequent to the point in time.

12. A computer-implemented method as claim 8 recites, wherein the changes in the characteristics of the network of resources comprises at least one of:
addition of a resource of the network of resources;
deletion of a resource of the network of resources;
modification of a resource of the cloud-based network of resources;
a change in at least one of a state, a status, or configuration data of a resource of the cloud-based network of resources;
a change in at least one of a price, a rate, or a cost data of a resource of the cloud-based network of resources;
a change in a relationship between a first resource of the network of resources and a second resource of the cloud-based network of resources;
a change in usage data for at least one of a resource of the network of resources or a group of resources of the cloud-based network of resources; or
a change in security data for a resource of the network of resources.

13. A computer-implemented method comprising:
presenting, on a screen, a graphical user interface including multiple portions;
presenting, in a first portion of the multiple portions of the graphical user interface, a diagram representing characteristics of a cloud-based network of resources; and
causing the diagram representing the characteristics of the cloud-based network of resources to be visually altered on the screen for a first period of time, the visual altering of the diagram being based at least in part on changes in the characteristics of the cloud-based network of resources over a second period of time.

14. A computer-implemented method as claim 13 recites, further comprising:
presenting a first graphical indicator which graphically represents a first subnet of the cloud-based network of resources;
presenting one or more graphical relationship indicators which graphically indicate that the first subnet includes a first resource and a second resource of the cloud-based network of resources;
presenting a second graphical indicator associated with the first resource; and
presenting a third graphical indicator associated with the second resource.

15. A computer-implemented method as claim 14 recites, further comprising:
detecting a particular change in the characteristics of the cloud-based network of resources associated with the first subnet during the second period of time; and
based at least in part on detecting the particular change, causing a visual change in a feature of the first graphical indicator

16. A computer-implemented method as claim 14 recites, further comprising:
detecting a particular change associated with at least one of the first resource or the second resource during the second period of time; and
based at least in part on detecting the particular change, causing a visual change in a feature of at least one of the second graphical indicator or the third graphical indicator.

17. A computer-implemented method as claim 13 recites, further comprising:
presenting, in a second portion of the multiple portions of the graphical user interface, a textual log representing the changes in the characteristics of the cloud-based network of resources over the second period of time.

18. A computer-implemented method as claim 13 recites, further comprising:
presenting, in a third portion of the graphical user interface, a control that is selectively operable to receive a selection of a point in time during the second period of time; and
causing the diagram representing the characteristics of the cloud-based network of resources to be visually altered on the screen for the second period of time subsequent to the point in time.

19. A computer-implemented method as claim 13 recites, wherein the diagram representing the characteristics of the cloud-based network of resources comprises at least one of:
a force-directed graph diagram;
a tree diagram;
a box topology diagram;
a chart; or
a graph.

20. A computer-implemented method as claim 13 recites, wherein the changes in the characteristics of the cloud-based network of resources comprise at least one of:
addition of a resource of the cloud-based network of resources;
deletion of a resource of the cloud-based network of resources;
modification of a resource of the cloud-based network of resources;
a change in at least one of a state, a status, or a configuration data of a resource of the cloud-based network of resources;
a change in at least one of a price, a rate, or a cost data of a resource of the cloud-based network of resources;
a change in a relationship between a first resource of the cloud-based network of resources and a second resource of the cloud-based network of resources;
a change in usage data for at least one of n resource of the cloud-based network of resources or a group of resources of the cloud-based network of resources; or
a change in security data for a resource of the cloud-based network of resources.
